(19) United States
(12) Patent Application Publication
(10) Pub. No.: US 2013/0102379 A1
(43) Pub. Date: Apr. 25, 2013

(54) Method of Simulation Reproductive Creatures

(71) Applicants: Candace Sargent, Pellham, AL (US); Ronald Holt, Pelham, AL (US)

(72) Inventors: Candace Sargent, Pellham, AL (US); Ronald Holt, Pelham, AL (US)

(21) Appl. No.: 13/345,728

(22) Filed: Jan. 8, 2012

Related U.S. Application Data
(60) Provisional application No. 61/430,859, filed on Jan. 7, 2011.

(51) Int. Cl. A63F 13/00

(52) U.S. Cl. CPC A63F 13/005
USPC 463/22; 463/31

(57) ABSTRACT

The present invention is an interactive simulation of animate creatures. This program is a computerized method of simulating reproductive virtual pets that display complex patterns of genetic variation, but which will not consume excessive amounts of system resources. This program is comprised of computerized simulations, manufacturers, compositions of matter and processes including reproducing objects, such as pets.

### CROSS-REFERENCE TO RELATED APPLICATIONS

Ser. No. 61/430,859

We are claiming the filing date of the related Provisional Application No. 61/430,859 of Jan. 7, 2011.

### STATEMENT REGARDING FEDERALLY SPONSORED RESEARCH OR DEVELOPMENT

Not Applicable

### NAMES OF THE INVENTORS

Candace Sargent, Pelham, Alabama-COINVENTOR

Cameron Holt, Pelham, Alabama-COINVENTOR

### REFERENCE TO SEQUENCE LISTING, A TABLE, OR A COMPUTER PROGRAM LISTING COMPACT DISK APPENDIX

Not Applicable

### BACKGROUND OF THE INVENTION

Computers are widely used for visual simulations, either of actual objects or fictional objects. Visual simulation often occurs in tandem with user input and the simulation reacts to such input; thus they are interactive simulations.

Interactive simulations of animate creatures are popular for multiple reasons. Animals and plants inherently fascinate people, but many people have neither the time nor the circumstances to raise them. Programs that simulate “virtual pets” provide an entertaining focus for a user's affection and attention. Such virtual pet programs generally require the user to provide certain input without which the simulated pet is shown to suffer. A common example is requiring the user to provide certain input that causes a simulated feeding, absent which the virtual pet will be shown to starve. Such simulations create a sense of responsibility, which is entertaining to adults and instructive to children.

However, virtual pets have a limited ability to hold a user's attention, owing to their uniformity. Unlike living creatures, programs that visually simulate living creatures have no variety, such that the user undergoes the same experience every time a pet is simulated. This is in stark contrast to plants and animals, no two of which are the same. Indeed, the major joy derived from raising another creature is recognition of the creature's uniqueness.

The unique characteristics of living creatures are due in large part to the nearly infinite potential of biological genetic variation. Although computerized methods have been used to simulate biological heredity, these have very low entertainment value. Up until the present, programs simulating genetic heredity have been instructional and clinical in nature, providing none of the aesthetic or emotional value that is provided by the simulation of a virtual pet. This is due in part to the serious resource constraints of both genetic simulations and virtual pet simulations.

Simulating virtual pets can consume excessive amounts of memory and processor time. This is partially due to the great visual detail in which a virtual pet must be rendered to confer an interesting appearance and due to the added value of animation of the pet's image. In some cases the virtual pet's simulation includes a physics engine and programming that simulates the interaction of the pet with other simulated objects. All of these elements can require large amounts of processor time, slowing down other applications. These elements typically also require large amounts of memory; not only does this leave less memory for other applications (or require the cost of extra memory installation), but the simulation may be slowed down by the time required to access memory.

Programs that simulate biological genetics also demand excessive system resources. This is primarily due to the fact that such programs simulate reproducing organisms. As the number of simulated organisms increases, the number of operations performed by the simulation will increase proportionally. The amount of memory dedicated to the simulation will also increase. Unless controls are set, the result can be very much like a computer virus, in which a program constantly demands an increasing amount of memory and processor time until all system resources are allocated to it

There is a long felt but unmet need in the art for computerized methods of simulating reproductive virtual pets that display complex patterns of genetic variation, but which will not consume excessive amounts of system resources.

### FIELD OF THE INVENTION

The present disclosure relates generally to computerized simulations, more particularly to simulations of reproducing objects, such as pets. Such simulations, as well as machines, manufacturers, compositions of matter and processes for use therewith are provided.

### DESCRIPTION OF RELATED ART

There are two patents that are somehow related to this application, however, they should not bar this application from becoming a patent. These patents are U.S. Pat. No. 6,993,513 and U.S. Pat. No. 5,544,305. They are each different and unique and, even if combined, should not bar the present application from being patented.

U.S. Pat. No. 6,993,513 is titled “interactive simulations utilizing a remote knowledge base.” This is a system that provides a goal based learning system utilizing a rule based expert training system to provide and educational experience. The main similarity between this invention and the present application is that they are both interactive. However, this patent is an educational tool that provides feedback based on the performance of the student and its focus is to assist the student in reaching a predefined goal. The present application serves an entertainment purpose, not an educational purpose and there are no predefined parameters to work around. The present application is for a computerized method of simulating reproductive virtual pets that display complex patterns of genetic variation, but which will not consume excessive amounts of system resources. Therefore the present application serves a different purpose than this patent and it also has the unique feature of not consuming excessive amounts of system resources.

U.S. Pat. No. 5,544,305 is titled “system and method for creating and executing interactive, interpersonal computer simulations.” The entire purpose of this patent is for the authoring editor to present an authoring user interface with a comic book metaphor form for the creation of simulations. This patent is similar to the present application in that there is a type of simulation present. However, it differs vastly because the simulations are completely different, one being a comic book metaphor and the other being virtual pets that display complex patterns of genetic variation. As in comparison to the prior mentioned U.S. Pat. No. 6,993,513, this application also varies greatly from U.S. Pat. No. 5,544,305 because it has the unique feature of not consuming excessive amounts of system resources.

### BRIEF SUMMARY OF THE INVENTION

The disclosure provides a computer-mediated method for rendering an image of a reproductive entity (“virtual pet”), wherein the appearance of the image is based at least in part on “genetic” variable for traits. The genetic variables can be combined with other genetic variables to produce progeny that appear to be related to the virtual pet. In some embodiments, the genetic variables associated with the virtual pet can be combined with genetic variable associated with another virtual pet, in which case the image rendered of the progeny will appear to be the product of the two parental pets. Of course, in some embodiments, there may be only one “parent,” or there may be more than two.

In some embodiments of the method the combination of genetic variables will follow a biological model. For example, the combination may follow the Mendelian model, in which there are at least two variables (“alleles”) that control a given aspect of the virtual pet's appearance (“trait”); when genetic variables are combined to generate progeny, for a given trait one allele is selected from each parent. The alleles selected for each trait will be independent of the alleles selected for any other traits. In other embodiments, the combination of genetic variables may follow other models, such as Morganian inheritance, in which some alleles are more likely to assort together than are others.

Such traits may be combined with unusual aspects of appearance, which do not vary based on any model of inheritance. Such unusual aspects may be based on simple, random determination, for example.

Embodiments of the method may further comprise steps to control the amount of resources that must be dedicated to rendering images of the virtual pet. Such steps may limit the reproduction of each virtual pet or limit the resources required to render each virtual pet (or both).

The disclosure also provides a data storage device comprising machine-readable instructions that will cause a computing device to perform any of the methods described herein. Also provided is a computing device that has been programmed to carry out any of the methods described here. Further provided is a computing system for performing the methods described.

### BRIEF DESCRIPTION OF THE DRAWINGS

FIG. 1 is a flow chart illustration of the operation of one embodiment of the present method, namely of the first generation of birthing;

FIG. 2 is an embodiment of the computer system disclosed herein; and

FIG. 3 is a flow chart illustration of the operation of one embodiment of the present method, namely of an interaction of two bunnies mating.

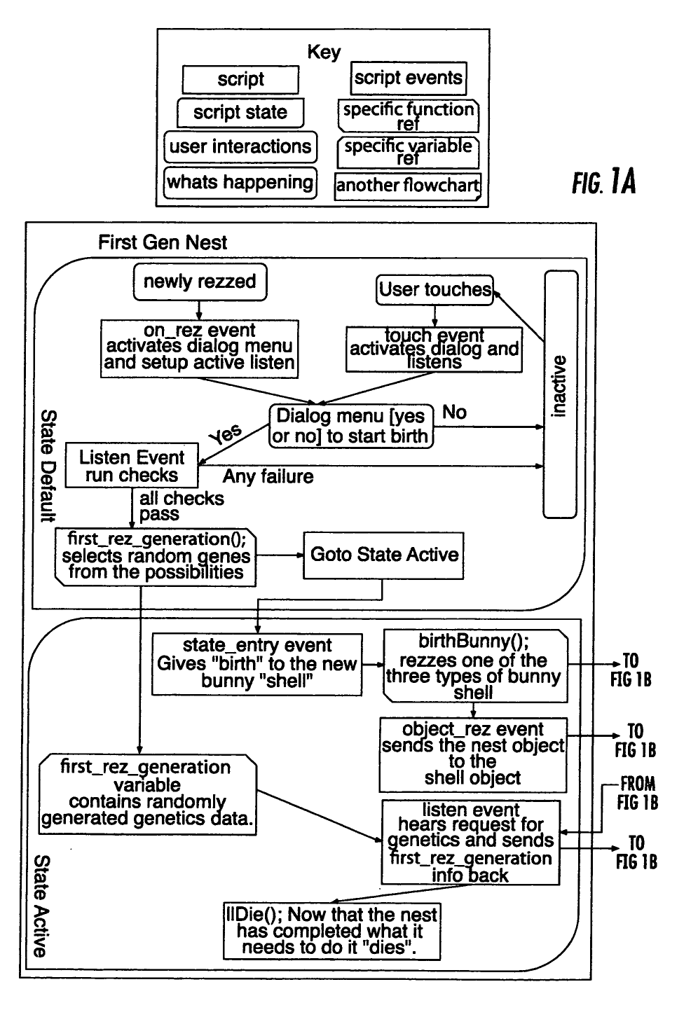

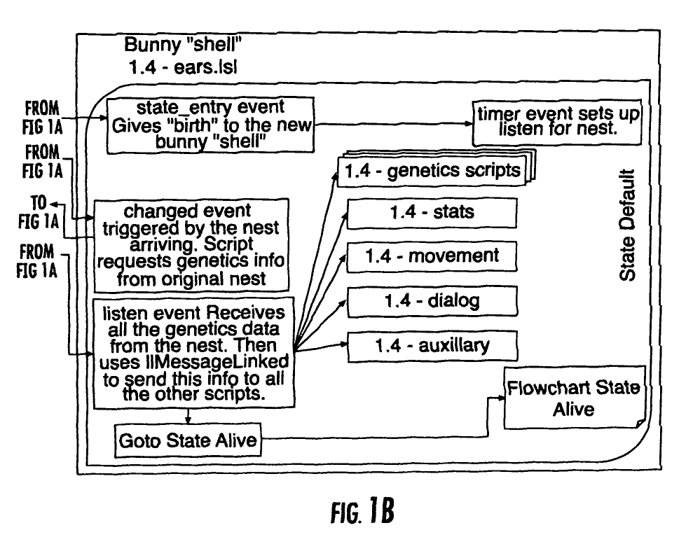

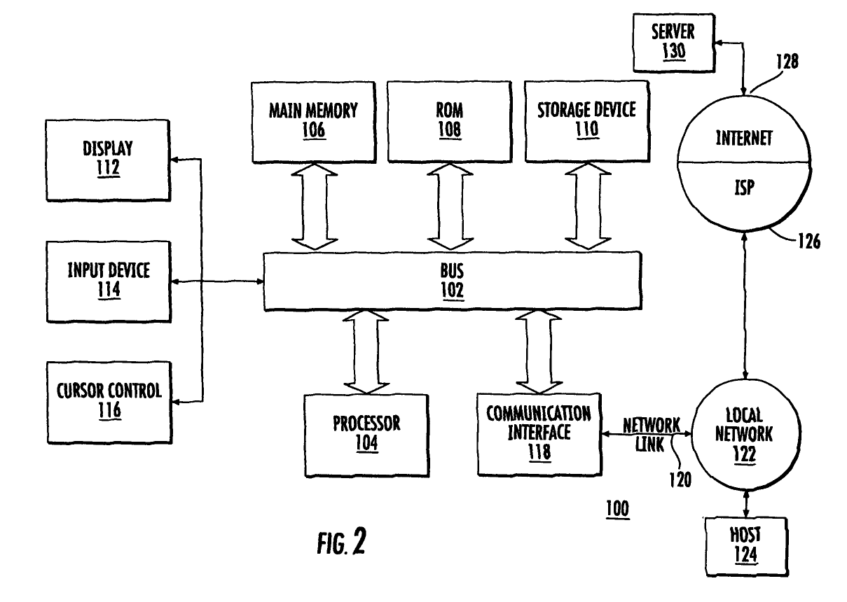

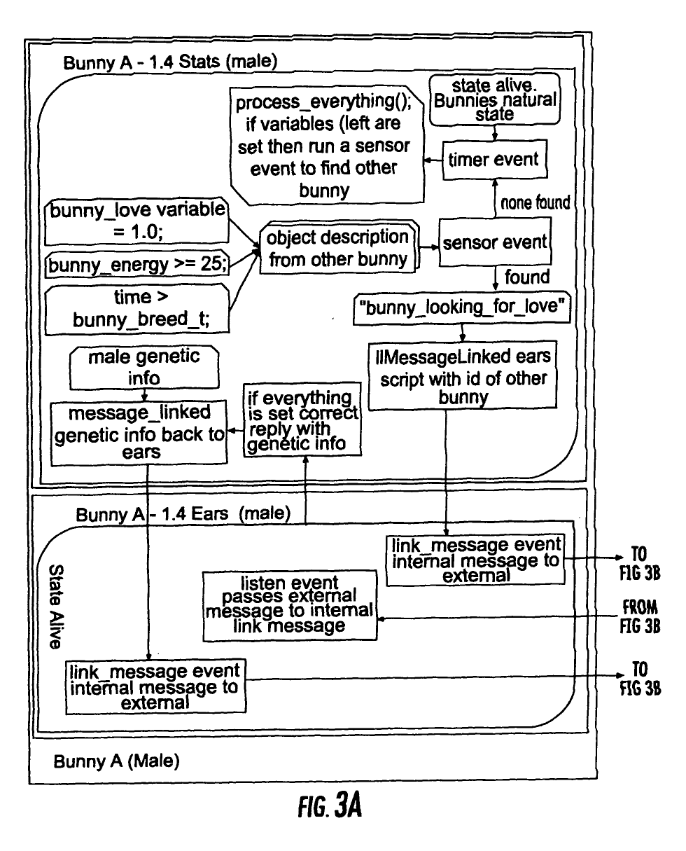

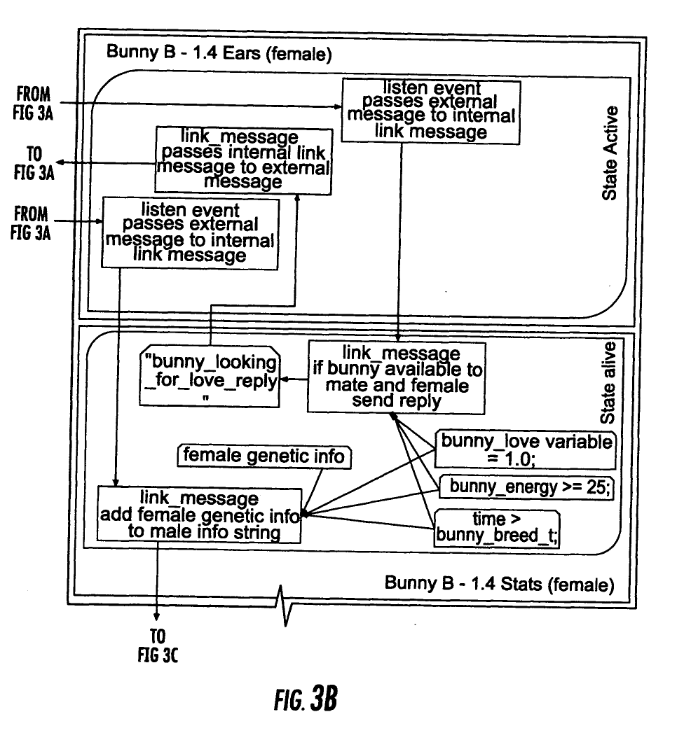

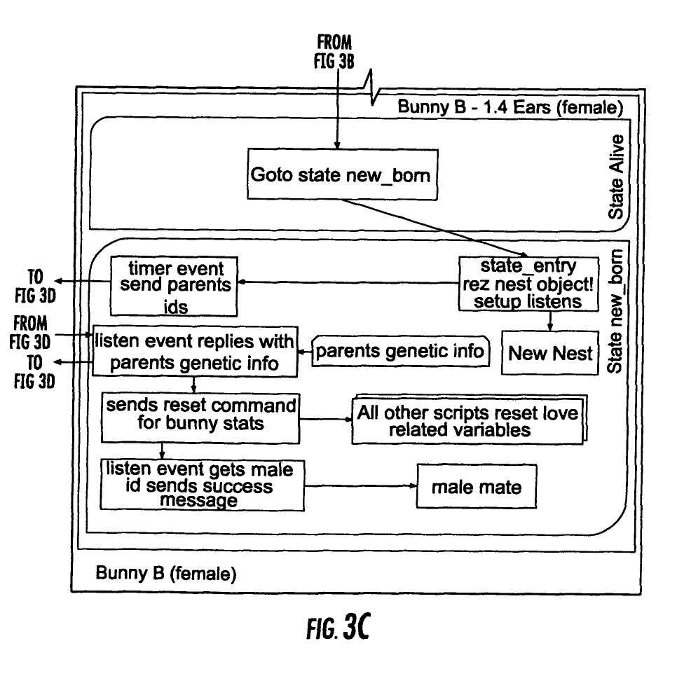

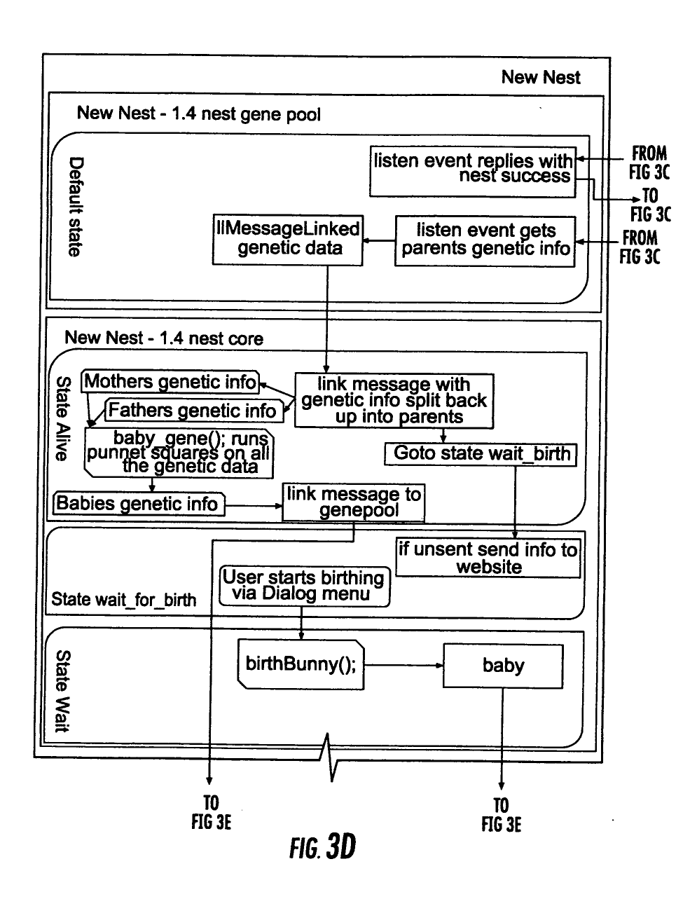

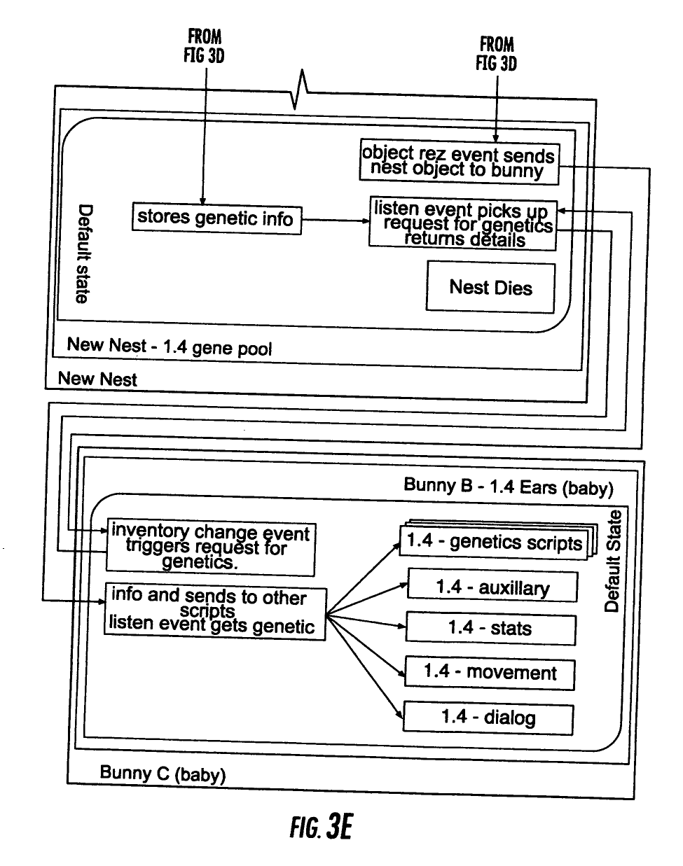

### DETAILED DESCRIPTION OF THE INVENTION

### Definitions

The term “data storage device” (DSD) as used herein refers to a machine-readable device that retains data that can be read by mechanical or electronic means, for example by a computer. Such devices are sometimes referred to as “memory,” although as used herein a machine-readable data storage device cannot comprise a human mind in whole or in part including human memory. A DSD may be classified as primary, secondary, tertiary or off-line storage. Examples of a DSD that is primary storage include the register of a central processing unit, the cache of a central processing unit, and random-access memory (RAM) that is accessible to a central processing unit via a memory bus (generally comprising an address bus and a data bus). Primary storage is generally volatile memory, which has the advantage of being rapidly accessible. A DSD that is secondary storage is not directly accessible to the central processing unit, but is accessible to the central processing unit via an input/output channel. Examples of a DSD that is secondary storage include a mass storage device, such as a magnetic hard disk, an optical disk, a drum drive, flash memory, a floppy disk, a magnetic tape, an optical tape, a paper tape, and a plurality of punch cards. A DSD that is tertiary storage is not connected to the central processing unit until it is needed, generally accessed robotically. Examples of a DSD that is tertiary storage may be any DSD that is suitable for secondary storage, but configured such that it is not constantly connected to the central processing unit. A DSD that is off-line storage is not connected to the central processing unit, and does not become so connected without human intervention. Examples of a DSD that is off-line storage may be any DSD that is suitable for secondary storage, but configured such that it is not constantly connected to the central processing unit, and does not become so connected without human intervention. Secondary, tertiary and offline storage are generally non-volatile, which has the advantage of requiring no source of electrical current to maintain the recorded information.

A DSD cannot be construed to be a mere signal, although information may be communicated to and from a DSD via a signal.

The term “electronic communications network as used herein refers to a network capable of transferring information spatially by conducting electrical or optical signals. The network itself cannot be construed to be a mere signal. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). Information sent via a packet-switched network might be for example electronic mail, an SMS text message, and a digital file sent via file transfer protocol (FTP). Information sent via a circuit-switched network may be for example a voice mail message, a facsimile message, an SMS text message and a digital file.

The term “processor” or “central processing unit” (CPU) as used herein refers to a software execution device capable of executing a sequence of instructions (“program”). The CPU comprises an arithmetic logic unit, and may further comprise one or both of a register and cache memory.

The term “virtual pet” as used herein refers to a computer-generated image that is intended to simulate an entity that displays some type of behavior. The “pet” need not have the appearance of an actual animal. It may have the appearance of plant, a microbe (or other organism), a fanciful creature, a robot, etc.

The term “variable” as used herein refers to a symbolic name corresponding to a binary value stored at a given memory address on a data storage device (although this address may change). The binary value may represent information of many types, such as integers, real numbers, Boolean values, characters and strings, as is understood in the art. As used herein, the value of a variable is always stored in a data storage device, and shall not be construed to refer to information only stored in a human mind. Any recitation of a variable implicitly requires the use of a data storage device.

The term “counting number” as used herein refers to a finite non-negative integer, including zero.

The term “including” as used herein is non-exclusive, and can be read to mean “including but not limited to” unless explicitly stated otherwise.

All pronouns should be read such that the singular encompasses the plural, the plural encompasses the singular, the male encompasses the female and the female encompasses the male.

### Method of Rendering an Image of a Virtual Pet

A computer-mediated method is provided for providing simulation of a reproductive virtual pet, comprising: (a) generating at least two allelic values for a trait variable, wherein the allelic values are selected from the group consisting of dominant, recessive, incompletely dominant, and co-dominant, the combination of the allelic values constituting a genotype; (b) rendering an image on a display device of a virtual pet comprising a variable aspect of appearance that is dependent upon the genotype; (c) varying the image in response to at least one of input from a user and the passage of an interval of time; (d) selecting a second genotype as a mate; (e) selecting an allelic value from the trait variable and an allelic value from the second genotype; (f) assigning a progeny trait variable with at least the selected allelic value from the trait variable and the selected allelic value from the second genotype, the combination of the selected allelic values constituting a progeny genotype; and (g) rendering an image of a progeny virtual pet comprising the variable aspect of appearance that is dependent upon the progeny genotype.

The trait variable controls an aspect of the appearance or behavior of the pet. For example, it may control the color of the pet (or a coloration pattern). Similarly, it may control the morphology of the pet; an illustrative example could be the ear morphology of a rabbit, such as lops ears or upright ears. The color, consistency, and shape of various parts of the pet can be independently controlled by one or more trait variables. In some cases multiple trait variables will control some aspect of appearance or behavior, for example in a simulation of epitasis. As is understood in the art, the value of the trait variable is stored on a data storage device to which a processor has access.

Each trait variable may contain a set of one or more allelic values. If a trait variable contains one allelic value, then the associated trait will be controlled by the allelic value. If the trait variable contains more than one allelic value, the trait will be controlled by a dominance scheme. The dominance scheme may imitate known natural dominance schemes (such as complete dominance, incomplete dominance, and co dominance), or it may be an artificial dominance scheme. Using a complete dominance scheme, if the trait variable contains a dominant allele value and a recessive allelic value, then the trait will reflect the dominant allele value regardless of the recessive allelic value. Using an incomplete dominance scheme, if the trait variable contains a dominant allele value and a recessive allele value, then the trait will reflect a mixture of both alleles. Using a co-dominance scheme, if the trait variable contains a dominant allele value and a recessive allele value, then the trait will be distinct than if the trait variable was homozygous for either the dominant or recessive allele.

The allelic values can be generated by any of numerous methods. For example, they may be generated using a random number generator and a list of alleles. In some embodiments each alleles is “weighted” so that some alleles are more likely to be randomly selected than others. Some embodiments of the method comprise allowing a user to select one or more alleles contained in the trait value. Other embodiments compromise a standard set of invariable “first generation” trait values.

The image of the virtual pet is provided on a peripheral display device. This can be any computer-controlled display that is known in the art. The “display” need not literally provide a visible image, for example in the case of a tactile display computer monitor. At least one aspect of the image is controlled by the “genotype” that is the sum of allelic values contained in the trait variable.

The image of the virtual pet will not be static, but will change at least periodically. This has the advantage of creating a more engaging simulation. The image may change, for example, in response to certain types of user input. In some embodiments of the method the user input will simulate a response to a type of interaction that commonly occurs between a human and a pet. Well known examples include feeding, holding, petting, watering, conversing, medicating, disciplining and rewarding.

In some embodiments the user input will change the image without necessarily simulating any common type of human-pet interaction. For example, the input could specify that the pet is to remain within a certain area, that the pet is to become dormant (status is saved and simulation program quits), toggling the animation of the pet image, toggling collision subroutines (if the program simulates other objects involved in “collisions”), that the pet is to become reproductive, that the pet must reproduce with mates meeting certain criteria, or that the pet should die.

The method comprises selecting a second genotype as a mate. In some embodiments the second genotype will be associated with another virtual pet. Some embodiments of the method comprise selecting a second genotype as a mate that is identical to the virtual pet's genotype, thus simulating a self-cross.

The method further comprises an allelic value from the trait variable and selecting an allelic value from the second genotype. In embodiments in which the trait variable and genotype comprise exactly one allelic value, the allelic value from the trait variable and the allelic value from the second genotype will be selected. In embodiments in which the trait variable and genotype comprise an even number of allelic values, half of the allelic values will be selected from each of the trait variable and genotype. When the number of allelic values for either or both of the trait variable or the second genotype is odd and greater than one, any suitable method may be adopted.

The method further comprises assigning a progeny trait with at least the selected allelic value from the trait variable and the selected allelic value from the second genotype, the combination of the selected allelic values constituting a progeny genotype. The allelic values will retain their dominance scheme as the basis for the progeny genotype.

The method further comprises rendering an image of a progeny virtual pet comprising the variable aspect of appearance that is dependent upon the progeny genotype. Thus the progeny virtual pet will display an aspect of appearance possibly reminiscent of the parent or one of the parents, but might display a hidden recessive trait instead. Using a few trait variables and a few allelic values for each, a vast number of different virtual pets can be produced. Using many possible allelic values for a few trait variables has the advantage of providing a high degree of variation while using very little memory.

The disclosure provides methods to reduce the resource demands of a reproductive virtual pet. Such methods can be generally grouped into two categories: Methods of controlling rates of reproduction, and methods of reducing the system demands of each individual.

Some embodiments of the method comprise storing a trait variable for more than one virtual pet in a centralized database. Because the “genetic” information associated with a given virtual pet does not change, the database may be remote from the system on which the virtual pet software is running (“the local system”) without requiring frequent communications between the two systems. This saves memory on the local system. Further embodiments of the method comprise storing all trait variables for all virtual pets running on a given system on a given remote database. Still further embodiments comprise using a remote database to store a subset of trait variables, all trait variables from a subset of virtual pets running on a given system, or a subset of trait variables from a subset of virtual pets running on a given system. In further embodiments the database may store trait variables from virtual animals running on separate systems.

Some embodiments of the method comprise displaying the image of the virtual pet only within a given area in its simulated surroundings. Methods known in the art often simulate the movement of virtual pets such that they move through their simulated surroundings until they encounter a barrier of some sort, such as a wall or a cliff; the movement of the virtual pets is limited by these simulated surroundings. However, these methods require subroutines to constantly compare the positions of the virtual pets to positions of other simulated objects and landscape, which consumes an inordinate amount of processor time. Simply establishing an area in which the virtual pet is permitted to roam serves the purpose of limiting the virtual pets movement without also tracking the locations of other objects; as a result, the virtual pet's movement is limited using little processor time. The area may be unchanging, or a user may set it. Allowing the user to change the area allows for more interesting behavior by the virtual pet, and gives the user the added participatory enjoyment of varying its roaming behavior. The area may be defined by any convenient means. The area could be designated by choosing certain borders, for example. Alternatively, the area could be a circle within a given radius of a given point. Other areas can be used as well.

Some embodiments of the method comprise displaying the virtual pet as stationary. The virtual pet may be stationary at all times, or only at certain times. Displaying the pet as stationary at certain times has the advantage of making the pet's behavior more interesting and potentially optimizing the resource use of the program simulating the pet. For example, the pet could be displayed to “settle down” (either becoming stationary or moving slowly) when system resources are limited. This could be accomplished by checking the availability of system resources periodically. Alternatively it could be accomplished by allowing a user to toggle the mobile/stationary status of the pet.

Some embodiments of the method comprise displaying the pet without animated features. “Animation” is distinguished from “movement” in this context in that movement is defined as the image of the pet translocating from one point to another, whereas animation involves moving features that translocate with the pet. An animated feature, for example, could be a simulated wink, which could be displayed whether or not the pet is moving from one place to another. When the pet displays no animation, it is said to be inanimate.

The pet may be inanimate at all times, or only at certain times. If the pet is inanimate at all times, it has the advantage of saving memory and processor time. If the pet is inanimate only at certain times, it has the advantage of making the pet's appearance more interesting and potentially optimizing the resource use of the program simulating the pet. For example, the pet could become inanimate only when the system resources are limited. This could be accomplished by checking the availability of system resources periodically. Alternatively it could be accomplished by allowing a user to toggle the animation status of the pet.

Various methods of controlling the reproduction of virtual pets are provided. Controlling the reproduction of the pets has the critical advantage of preventing virtual pet programs from becoming de facto viruses, consuming ever increasing amounts of memory and processor time until inevitably there is too little memory left to run the operating system and/or all tasks come to a near-halt because the virtual pet programs demand such a high percentage of processor time.

Some embodiments of the method comprise providing a brood variable associates with a given pet, wherein the brood variable is a counting number. Initially the brood variable will be a positive counting number (not zero), indicating the number of times the pet will reproduce. The brood variable may, for example, be reduced by one each time the pet produces an offspring. If the pet produces a brood of more than one offspring, then the brood variable may be reduced by the total number of offspring, by one, or by some other value calculated to reflect the potential burden on system resources created. In further embodiments of the method the brood variable may be affected by other factors. For example, the brood variable may be reduced to reflect simulated “ill health” of the pet, for example if the pet does not adequately eat, drink, sleep, and or play. One exemplary embodiment of the method comprises reducing the brood variable by one each time the pet is given no food or water for a given period of time. In some further embodiments, the pet may become motionless and cease responding to user input and/or the virtual environment until it is fed; in other embodiments the brood variable drops once per malnutrition incident.

Once the brood variable reaches zero, the pet cannot reproduce. In some embodiments of the methods the pet disappears at this point. In some embodiments, an aspect of the pet is displayed differently once the brood variable reaches zero. This has the advantage of providing continued entertainment value from the virtual pet even after it can no longer be bred. In some exemplary embodiments, the pet with a brood variable value of zero will be displayed to “assist” other pets in some way. Such embodiments have the advantage of encouraging the user to continue to maintain the pet with a brood variable of zero, even if the user's primary interest is the simulated breeding aspect of the pets. Such assistance can take the form of an increase to other pets' breeding activity, resistance to “starvation” or other undesirable circumstances that might reduce breeding activity, or an increase in their brood number.

Some embodiments of the method comprise requiring specific input from the user to effect breeding of the pet. For example, the user could be required to follow a specific feeding regimen; such a feeding regimen could comprise providing the pet with a certain quality of food, which might not easily be available. Only a certain quantity might be available at a given time, or the user could be required to submit payment to obtain it. The user might be required to provide input that simulates improving the pet's living conditions (providing the company of other pets, showing the pet attention, providing the pet with time and shelter for rest, providing toys, providing bedding, etc.) to effect breeding.

Causing the pet to lose its ability to breed temporarily after each breeding attempt may also control breeding. The loss may last for a certain set amount of time, or may last until the user provides certain inputs. The required inputs may be of the same types described above as generally appropriate to effect breeding.

### Systems and Devices

A system is provide comprising a processor, a display, and at least one memory storage device, said at least one memory storage device comprising a module for rendering an image of a virtual pet, a module for dictating the movement of the virtual pet, a module for determining allelic values, a module for receiving input from users, and a module for receiving input from outside systems.

A computer system is provided for performing the methods disclosed. The computer system includes a bus or other communication mechanism for communicating information, and a processor coupled with bus for processing information. The computer system also includes a primary data storage device, such as random access memory (RAM) or other dynamic storage device coupled to the bus for storing information and instructions to be executed by the processor. The primary data storage device also may be used for storing temporary variable or other intermediate information during execution of instructions to be executed by the processor. The computer system further includes a read only memory (ROM) or other static storage device coupled to the bus for storing static information and instructions for the processor. A secondary data storage device, such as a magnetic disk or optical disk, is provided and coupled to the bus for storing information and instructions.

The computer system may be coupled via to a display, such as a cathode ray tube (CRT), for displaying information to a user. An input device, including alphanumeric and other keys, is coupled to the bus for communicating information and command selections to the processor. Another type of user input device is cursor control, such as a mouse, a trackball, or cursor direction keys for communicating direction information and command selections to the processor and for controlling cursor movement on the display. This input device typically has two degrees of freedom in two axes, a first axis (e.g., x) and a second (e.g., y) that allows the device to specify positions in a plane.

The invention is related to the use of the computer system for the methods disclosed herein. According to one embodiment of this invention, the method is performed by the computer system in response to the processor executing one or more sequences of one or more instructions contained in the primary data storage device. Such instructions may be read into the primary data storage device from another data storage device. Execution of the sequences of instructions contained in the primary data storage device causes the processor to perform the process steps described herein. One or more processors in a multi-processing arrangement may also be employed to execute the sequences of instructions contained in the main memory. In alternative embodiments, hard-wired circuitry may be used in place of or in combination with software instructions to implement the invention. Thus, embodiments of the invention are not limited to any specific combination of hardware circuitry and software.

Also provided is a memory storage device on which is recorded an instruction or set of instructions which, when read y a computing device, causes the computing device to perform any of the methods disclosed herein.

### Exemplary Embodiment

An exemplary embodiment of the method comprises displaying an image of a rabbit (herein after a “bunny”) in the milieu of a “virtual world,” such as the online game environment Second Life O. In such virtual worlds a user control a simulated person (called and “avatar”) interacting with a virtual environment and other avatars, as is understood in the art.

The rabbit's appearance is controlled by trait variable for fur patter, eye color, and ear type. All trait variables contain two allelic values. Dozens of allelic values for fur pattern are possible, most simulating known alleles in rabbits. In addition, alleles exist for the degree of shine or “glow” that can be depicted. Ear type has three phenotypes: normal (upright ears), lop ears, and half-lop ears (a half-lop rabbit has one upright ear and one lop ear). Dozens of allelic values for eye color are possible as well. All traits follow the Mendelian rules of dominance.

A user may obtain a nest without parents when the user first purchases the software. The allelic values of the trait variables for such a “first generation” or “P” nest are determined randomly. Any allelic value may be randomly selected, although some allelic values are “weighted” to be more likely than others. This simulates rarity in some traits and commonness in others. The nest is displayed having the appearance of a rabbit nest in a basket. Each nest also has a “gender,” male or female.

The nest produces only one baby bunny. The nest will not change until the user provides input to “kindle” the nest; when the user does so, the nest is replaced by the image of a small baby rabbit having an appearance dictated by the trait variables. There is a waiting period of one week between kindling and the “birth” of the baby bunny. The nest does not need to be fed, never needs to sleep, and otherwise requires no attention from the user until kindling.

Some allelic values cause the bunny to be displayed in a way that is fanciful and not at all realistic. For example, there is a recessive fur pattern allele that causes the bunny to appear as a “dust bunny” (a collection of hair and dust). Likewise, there is a recessive fur pattern allele that causes the bunny to appear as a six-eyed slimy: alien bunny,” a yellow puffy “marshmallow bunny,” and a chocolate bunny.

Some visual aspects of the bunny are not determined by the trait variables. For example, a nest that is a P nest, and is the product of a mating of two bunnies that are the progeny of the same parent (siblings), will in a set percentage of cases produce a “mutant.” A mutant has a body part that does not have the same coat pattern as the rest of the bunny, but has a randomly determined coat patter. This aspect of appearance has no impact on the trait variable and does not influence the appearance of the bunny's progeny.

Upon birth, status values are assigned to at least four status variables. The variables are displayed if the user provides certain input. Three of the status variables are displayed under the name “happiness,” “love,” and “energy.” A fourth status variable may be displayed under the name “nutrition,” or two separate variables may be displayed for “hunger” and “thirst.” Each status variable is assigned an integer value from 0-100, which is displayed as a percentage. The status values change over time and in response to certain user input and events. The value of one status variable may be increased or decreased by the value of another status variable. A brood variable is assigned to the new bunny at a value of 15.

The bunny starts life with energy of 75%. This decreases while the bunny is “awake,” moving, responding to user input and responding to events in the virtual environment. When energy reaches 0%, the bunny spontaneously falls asleep. The sleeping bunny does not move (although it may be animated) and will not respond to events in the virtual environment. While asleep, energy increases. The user may interrupt the bunny's sleep period and cause it to resume waking behavior at any time when its energy is above 6%. Of courser, the bunny may spontaneously fall asleep soon after waking if its energy is too low. Energy increases in response to certain user input (providing “boosts” in the form of simulated drugs) or if the bunny is proximate to a post-reproductive elder virtual bunny, as described below.

Happiness does not change merely in response to the passage of time. Happiness decreases if energy is either above or below 50%. Happiness increases when a user's avatar “wears” the bunny, which manifests itself as an image of the avatar holding the bunny. Happiness increases when a virtual object that is recognized as food and/or water is proximate to the bunny. Happiness can also be increased by simulated drugs and proximity to a post-reproductive elder virtual bunny.

Status variable referred to as “hunger” or “thirst,” (“nutrition” replaces both hunger and thirst-hereinafter these three status variables are referred to as “nutrition” for convenience) increase constantly unless the bunny is near a virtual object that is recognized as food and/or water. When the bunny is near a food or water object, the food or water object will disappear (having been consumed) and the bunny's nutrition will be set to 0%. This will occur once per hour, unless the bunny's nutrition is 0%. If neither food nor water objects are available once per hour, the bunny's nutrition increases. If the bunny is not near a food or water object for 72 hours, the bunny will “starve.” The bunny stops moving, is inanimated, is displayed un grey-scale, and its brood variable is reduced by 1. The starvation state is lifted if user input is received providing the necessary food and water object. The brood number is not restored by such user inputs. After a starved bunny has been fed, it will consume triple the amount of usual food over the next 24 hours, and at that point it is no longer starved and it resumes activity normally.

The level of love determines whether the virtual bunny is reproductively competent at a given time. All bunnies are reproductively incapable for seven days after time of birth. After that, the bunny must have 100% love to reproduce. Love increases while happiness is above 75%. Love increases while energy is above 25%. Love is reduced to 0% when the bunny is crossed with another bunny. Love increases in response to certain user input (providing “boosts” in the form of simulated drugs) or if the bunny is proximate to a post-reproductive elder virtual bunny, as described below.

The bunny will appear to hop and walk in an area corresponding to a given radius of a point selected by the user. However, the user has the option to deactivate movement to save system resources, in which case the bunny will not move. It may still remain animated. The bunny may be animated to appear to breath, wiggle its nose, and engage in other minor gestures. This animation may also be toggled by the user. Whether animation is toggled on or off is independent of whether movement is toggled on or off.

In the virtual environment, objects in the game generally interact with one another through “collisions.” A collision occurs when the surface of one three-dimensional game object intersects with the surface of another three-dimensional game object. Because the geometry of the game object is complex, programs that check for collisions demand a large amount of processor time. This can create “lag” in the virtual environment, in which tasks are performed too slowly to provide an adequate visual simulation.

To save system resources and prevent the lag that has generally plagued attempts to simulate breeding creatures, the exemplary embodiment of the software minimizes the need to check for collisions. When a bunny is not moving, it cannot engage in collisions (other objects would pass right through it). The user has the option of toggling movement of the bunny; when movement is off, collisions do not occur. The interactions of the bunny between other bunnies (such as mates and elders), food objects, water objects, and “boost” objects does not involve collisions; rather such interactions occur when the distance from a point inside the image of the bunny is no more than a maximum distance to a point inside the image of the food object, water object, other bunny, etc. Calculating a linear distance is a very simple calculation compared to determining whether an intersection occurs between the outer surfaces of two three-dimensional objects, and consequently requires fewer operations be performed by the processor for the same task. In addition, it is desirable to limit the area over which the virtual bunny will roam, as otherwise a user's virtual pets might become scattered and lost. In the exemplary embodiment this is also achieved by simply defining the area over which the bunny may roam as a linear radius from a given point. The user may set the radius and the point. In the absence of any user input, the area is set as 5 meters (in the virtual setting) from the point at which the bunny is born.

Breeding occurs when the bunny's love reaches 100% and the user so specifies the bunny is to breed. The user must specify the mate. The mate may be a specific bunny (of the opposite gender). In addition, the user may specify that the mate may be any bunnies associated with the same user, any bunnies associated with an individual other user, or any bunnies associated with any one of a group of users. Breeding does not require a collision between two bunnies Breeding requires that the bunny to be bred and an allowed mate (who also must be reproductively capable) are within a given distance of one another; the user may specify the distance, and its default value is five meters. Furthermore, breeding requires that specific food objects called “breeding food” be given to the bunny.

The bunny will interact with five types of food objects. The first type is “pet food,” which decreases the nutrition level to 0%. Pet food is not a type of breeding food. There are three types of breeding food. The basic breeding food decreases nutrition to 0%, and makes the bunny capable of breeding. The premium breeding food increases energy and happiness, decreases nutrition to 0%, and makes the bunny capable of breeding. The aphrodisiac breeding food increases love, decreases nutrition to 0%, and makes the bunny capable of breeding. The archetype food increases love, increases energy, increases happiness, decreases nutrition to 0% and makes the bunny capable of breeding; furthermore, the archetype food determines the characteristics of the bunny should it reach elder hood.

One allele for each trait variable is randomly selected from each of the two bunnies and serves as the allelic values for the progeny's trait variables. If the parents are identified as siblings, a random determination is made as to whether the progeny will be shown with a mutation. If the progeny will be shown with a mutation, the fur pattern and a body part are chosen for the mutation. A nest is then shown at the female's parent's position at the time of breeding. The brood variables for both parents decrease by 1. If either parent's brood variable reaches zero, that parent is designated an “elder.”

The designation of pot-reproductive bunnies as elders both limits reproduction and boosts the entertainment value of the pet after it can no longer breed. Although an elder bunny does not breed, it enables the user's reproductive bunnies to breed. Upon reaching a zero brood value, the bunny may assume the properties of any of three calibers of elder, depending solely on diet.

A bunny that has eaten only archetype food will become a “sage” when its brood value reaches zero. A sage provides a 3% bonus to one “bonus” status variable to other bunnies within 10 meters in the virtual setting; the bonus status variable is determined randomly when the bunny's brood variable reaches zero.

If the sage is given food other than archetype food during the first 60 days of its elder hood, it becomes “elder” (described below). If the sage is given only archetype food during this period, it becomes a patriarch or matriarch. The patriarch or matriarch provides a 5% bonus to the bonus status variable to other bunnies within 15 meters in the virtual setting.

If a bunny has not been exclusively given archetype food, when it reaches zero brood value it becomes an “elder.” The elder provides a 1% bonus to one bonus status variable to other bunnies within 5 meters in the virtual setting; the bonus status variable is determined randomly when the bunny's brood variable reaches zero.

### CONCLUSIONS

The foregoing description illustrates and describes the processes, machines, manufactures, compositions of matter, and other teachings of the present disclosure. Additionally, the disclosure shows and describes only certain embodiments of the processes, machines, manufactures, compositions of matter and other teachings disclosed, but, as mentioned above, it is to be understood that the teachings of the present disclosure are capable of use in various other combinations, modifications, and environments and is capable of changes or modification within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein.

1. (canceled)

2. (canceled)

3. (canceled)

4. (canceled)

5. (canceled)

6. A computer-mediated method for providing simulation of a reproductive virtual pet, comprising:
(a) generating at least two allelic values for a trait variable, wherein the allelic values are selected from the group consisting of dominant, recessive, incompletely dominant, and co-dominant, the combination of the allelic values constituting a genotype;
(b) rendering an image on a display device of a virtual pet comprising a variable aspect of appearance that is dependant upon the genotype;
(c) varying the image in response to at least one of input from a user and the passage of an interval of time;
(d) selecting a second genotype as a mate;
(e) selecting an allelic value from the trait variable and an allelic value from the second genotype;
(f) assigning a progeny trait variable with at least the selected allelic value from the trait variable and the selected allelic value from the second genotype, the combination of the selected allelic values constituting a progeny genotype; and
(g) rendering an image of a progeny virtual pet comprising the variable aspect of appearance that is dependent upon the progeny genotype.

7. The method as in claim 6, further comprised of trait variables, that:
(a) control an aspect of the appearance or behavior of the pet;
(b) control the morphology of the pet;
(c) by one or more trait variables can independently control the color, consistency, and shape of various parts of the pet;
(d) by multiple trait variables can sometimes control some aspect of appearance or behavior;
(e) the value of which is stored on a data storage device to which a processor has access.
(f) may contain a set of one or more allelic values;
(g) if the trait variable contains one allelic value, then the associated trait will be controlled by the allelic value; and
(h) if the trait variable contains more than one allelic value, the trait will be controlled by a dominance scheme

8. The method as in claim 7, further comprised of a dominance scheme which:
(a) may imitate known natural dominance schemes such as complete dominance, incomplete dominance and co dominance or it may be an artificial dominance scheme;
(b) using a complete dominance scheme, if the trait variable contains a dominant allele value and a recessive allelic value, then the trait will reflect the dominant allele value regardless of the recessive allelic value;
(c) using an incomplete dominance scheme, if the trait variable contains a dominant allele value and a recessive allele value, then the trait will reflect a mixture of both alleles; and
(d) using a co-dominance scheme, if the trait variable contains a dominant allele value and a recessive allele value, then the trait will be distinct than if the trait variable was homozygous for either the dominant or recessive allele.

9. The method of claim 8, further comprising numerous methods to generate allelic values which:
(a) may be generated using a random number generator and a list of alleles;
(b) in some embodiments, each allele is “weighted” so that some alleles are more likely to be randomly selected than others;
(c) in some embodiments, comprise allowing a user to select one or more alleles contained in the trait value; and
(d) in some embodiments comprise a standard set of invariable “first generation” trait values.

10. The method of claim 9, further comprising an image of the virtual pet being provided on a peripheral device which:
(a) can be any computer-controlled display that is known in the art;
(b) the “display” need not literally provide a visible image, as in the case of a tactile display computer monitor; and
(c) at least one aspect of the image is controlled by the “genotype” that is the sum of allelic values contained in the trait variable.

11. The method of claim 10, further comprising an image that will not be static which:
(a) will change at least periodically;
(b) may change in response to user input;
(c) in some embodiments of the method, the image will change in response to user input which will simulate a response to a type of interaction that commonly occurs between a human and a pet; and
(d) in some embodiments, the user input will change the image without necessarily simulating any common type of human-pet interaction.

12. The method of claim 11, further comprising selecting a second genotype as a mate which:
(a) in some embodiments the second genotype will be associated with another virtual pet; and
(b) in some embodiments of the method comprise selecting a second genotype as a mate that is identical to the virtual pet's genotype, thus simulating a self-cross.

13. The method of claim 12, further comprising an allelic value from the trait variable and selecting an allelic value from the second genotype which:
(a) in embodiments in which the trait variable and genotype comprise exactly one allelic value, the allelic value from the trait variable and the allelic value from the second genotype will be selected;
(b) in embodiments in which the trait variable and genotype comprise an even number of allelic values, half of the allelic values will be selected from each of the trait variable and genotype; and
(c) when the number of allelic values for either or both of the trait variable or the second genotype is odd and greater than one, any suitable method may be adopted.

14. The method as in claim 13, further comprising:
(a) assigning a progeny trait with at least the selected allelic value from the trait variable and the selected allelic value from the second genotype, the combination of the selected allelic values constituting a progeny genotype; and
(b) the allelic values will retain their dominance scheme as the basis for the progeny genotype.

15. The method of claim 14, further comprising:
(a) rendering an image of a progeny virtual pet comprising the variable aspect of appearance that is dependent upon the progeny genotype thus the pet displaying an aspect of appearance possibly reminiscent of the parents or one of the parents, but might display a hidden recessive trait instead;
(b) using a few trait variable and a few allelic values for each pet to produce a vast number of different virtual pets; and
(c) using many possible allelic values for a few trait variables, thus giving the advantage of providing a high degree of variation while using very little memory.

16. The method of claim 15 further comprising methods to reduce the resource demands of a reproductive virtual pet comprising:
(a) methods to control rates of reproduction; and
(b) methods of reducing the system demands of each individual.

17. The method of claim 16 further comprised of:
(a) storing a trait variable for more than one virtual pet in a centralized database, which may be remote from the system on which the virtual pet software is running without requiring frequent communications between the two systems thus saving memory on the local system;
(b) further embodiments of the method comprise storing all trait variables for all virtual pets running on a given system on a given remote database;
(c) further embodiments of the method comprise using a remote database to store a subset of trait variables, all trait variables from a subset of virtual pets running on a given system, or a subset trait variable from a subset of virtual pets running on a given system; and
(d) further embodiments of the method compromise the database which may store trait variables from virtual animals on separate systems.

18. The method of claim 17, further comprising:
(a) embodiments of the method that comprise displaying the image of the virtual pet only within a given area in its simulated surroundings;
(b) establishing an area in which the virtual pet is permitted to roam thereby serving the purpose of limiting the virtual pets movement without also tracking the locations of other objects, limiting the virtual pet's movement and using little processor time;
(c) the area established may be unchanging or a user may set it;
(d) the area established may be defined by any convenient means;
(e) the area established may be designated by choosing certain borders;
(f) the area established may be a circle within a given radius of a given point; and
(g) other areas may be used as well.

19. The method of claim 18, further comprising embodiments of the method displaying the virtual pet as stationary where:
(a) the pet may be stationary at all times or only at certain times;
(b) the pet could be displayed to “settle down” by becoming stationary or by moving slowly thereby optimizing the resource use of the program simulating the pet; and
(c) the pet could be displayed to “settle down” by checking the availability of the system resources periodically or by allowing a user to toggle the mobile/stationary status of the pet.

20. The method of claim 19, further comprising:
(a) displaying the pet without animated features, “animation” being distinguished from “movement” in this context in that movement is defined as the image of the pet translocating from one point to another, whereas animation involves moving features that translocate with the pet and in “animate” being defined as the pet displaying no animation;
(b) the pet being capable of being inanimate at all times, thus saving memory and processor time, or only at certain times, thus having the advantage of making the pet's appearance more interesting and potentially optimizing the resource use of the program simulating the pet; and
(c) the pet becoming inanimate only when the system resources are limited being accomplished by either by checking the availability of system resources periodically or by allowing a user to toggle the animation status of the pet.

21. The method of claim 20 further comprising controlling the reproduction of virtual pets by:
(a) providing a brood variable associated with a given pet, wherein the brood variable is a counting number which is initially a positive counting number that is not zero and that may be reduced by one each time the pet produces an offspring, or by more than one, one or some other value calculated to reflect the potential burden on system resources created if the pet produces a brood of more than one offspring;
(b) providing a brood variable that may be reduced to reflect simulated “ill health” of the pet which can occur but is not limited too causes being the pet not eating, drinking, sleeping and/or playing;
(c) providing a brood variable that may be reduced by one each time the pet is given no food or water for a given period of time;
(d) the pet becoming motionless and cease responding to user input and/or the virtual environment until it is fed;
(e) providing a brood variable that drops once per malnutrition incident;
(f) providing a brood variable that once the brood variable reaches zero, the pet cannot reproduce and may or may not disappear;
(g) providing a brood variable that once the brood variable reaches zero, does not disappear but an aspect of the pet is displayed differently and now may “assist” other pets by taking the form of an increase to other pets breeding activity, resistance to “starvation” or other undesirable circumstances that might reduce breeding activity, or an increase in their brood number;
(h) requiring specific input from the user to effect breeding of the pet;
(i) being required to follow a certain feeding regime to effect breeding;
(j) requiring providing input that simulates improving the pet's living condition to effect breeding; and
(k) causing the pet to lose its ability to breed temporarily after each breeding attempt

22. A system for performing the methods disclosed comprising a processor, a display and at least one memory storage device, said at least one memory storage device comprising a module for rendering an image of a virtual pet, a module for dictating the movement of the virtual pet, a module for determining allelic values, a module for receiving input from users, and a module for receiving input from outside systems.

23. The system of claim 22, further comprising:
(a) a computer system that includes a bus or other communication mechanism for communicating information, a processor coupled with bus for processing information, a primary data storage device, such as random access memory (RAM) or other dynamic storage device coupled to the bus for storing information and instructions to be executed by the processor, the primary data storage device also may be used for storing temporary variable or other intermediate information during execution of instructions to be executed by the processor;
(b) a read only memory (ROM) or other static storage device coupled to the bus for storing static information and instructions for the processor; and
(c) a secondary data storage device, such as a magnetic disk or optical disk coupled to the bus for storing information and instructions.

24. The system of claim 23 further comprising:
(a) the computer system may be coupled to a display, such as a cathode ray tube (CRT) for displaying information to a user;
(b) an input device, including alphanumeric and other keys, may be coupled to the bus for communicating information and command selections to the processor;
(c) a type of user input device is cursor control, such as a mouse, a trackball, or cursor direction keys for communicating direction information and command selections to the processor and for controlling cursor movement on the display;
(d) this input device typically has two degrees of freedom in two axes which are a first axis (e.g. x) and a second (e.g. y) that allows the device to specify positions in a plane; and
(e) a memory storage device on which is recorded an instruction or set of instruction which, when read by a computing device, causes the computing device to perform any of the methods disclosed herein.

25. The method of use of the system of claim 24 comprising:
(a) the method being performed by the computer system in response to the processor executing one or more sequences of one or more instructions contained in the primary data storage device, those instructions may be read into the primary data storage device from another data storage device, execution of the sequences of instructions contained in the primary data storage device causes the processor to perform the process steps described herein;
(b) the method of use including but not being limited to one or more processors in a multi-processing arrangement may also be employed to execute the sequences of instructions contained in the main memory;
(c) the method of use including but not being limited to hand wired circuitry may be used in place of or in combination with software instructions to implement the invention; and
(d) the embodiments of this invention are not limited to any specific combination of hardware circuitry and software.
